(19) United States
(12) Patent Application Publication
(10) Pub. No.: US 2026/0022793 A1
(43) Pub. Date: Jan. 22, 2026

(54) SYSTEMS AND METHODS OF FIRE PROTECTION PIPE FITTINGS

(71) Applicant: Tyco Fire Products LP, Cranston, RI (US)

(72) Inventors: Jeremy Tyler Cogswell, Johnston, RI (US); Narayana Prasad Rayapati, Cranston, RI (US); Christina Madelyn Demopulos, Greenville, RI (US); Sandra M. Lippka, Warwick, RI (US); Mathew R. Ancone, Warwick, RI (US); Prashant Ashok Kulkarni, Cranston, RI (US); Barbara L. Churchill, Pawtucket, RI (US)

(73) Assignee: Tyco Fire Products LP, Cranston, RI (US)

(21) Appl. No.: 18/879,662

(22) PCT Filed: Sep. 18, 2023
(86) PCT No.: PCT/US2023/033017

§ 371 Date: Dec. 27, 2024

Related U.S. Application Data
(60) Provisional application No. 63/407,855, filed on Sep. 19, 2022.

(51) Int. Cl. F16L 41/12; A62C 35/68

(52) U.S. Cl. CPC F16L 41/12; A62C 35/68

(57) ABSTRACT

A pipe fitting includes a body, a first connector on a first side of the body, and a second connector on a second side of the body. The first connector, the body, and the second connector form an internal passageway along an axis between a first port of the first connector and a second port of the sprinkler connector. The first port is shaped to have a concave curvature relative to a plane perpendicular to the axis and extending through the internal passageway.

### CROSS-REFERENCE TO RELATED APPLICATIONS

This application claims the benefit of and priority to U.S. Provisional Application No. 63/407,855, filed Sep. 19, 2022, the disclosure of which is incorporated herein by reference in its entirety.

### BACKGROUND

Sprinkler systems can be provided in buildings to address fire conditions. Sprinkler systems can include fire protection sprinklers that connect with piping systems to receive fluid to address the fire conditions.

### SUMMARY

At least one aspect relates to a pipe fitting. The pipe fitting includes a body, a first connector on a first side of the body, and a second connector on a second side of the body. The first connector, the body, and the second connector form an internal passageway along an axis between a first port of the first connector and a second port of the second connector. The first port is shaped to have a concave curvature relative to a plane perpendicular to the axis and extending through the internal passageway.

At least one aspect relates to a pipe strap fitting. The pipe strap fitting includes a body, a sprinkler connector extending from the body along an axis to an outlet, and a pipe connector extending on an opposite side of the body from the sprinkler connector along the axis to an inlet. The sprinkler connector, the pipe connector, and the body form an internal passageway along the axis between the inlet and the outlet. The pipe connector includes an inner wall forming the inlet and an outer wall, the inner wall and the outer wall forming a gasket receiver between the inner wall and the outer wall, an edge of the outer wall further from the plane than an edge of the inner wall, the inner wall and the outer wall having concave curvatures relative to the plane.

At least one aspect relates to a tee outlet fitting. The tee outlet fitting includes a body, a sprinkler connector extending from the body along an axis to an outlet, and a pipe connector extending on an opposite side of the body from the sprinkler connector along the axis to an inlet. The pipe connector, and the body form an internal passageway along the axis between the inlet and the outlet. The pipe connector includes a wall forming the inlet on an inner side of the wall and a gasket receiver on an outer side of the wall. The wall extends further from the plane at one or more outer points outward from the axis than one or more inner points aligned with the axis.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a schematic diagram of an example of a fire protection system.

FIG. 2 is a perspective view of an example of a pipe fitting.

FIG. 3 is a side view of an example of a pipe fitting.

FIG. 4 is a cross-section view of an example of a pipe fitting.

FIG. 5 is a cross-section view of an example of a pipe fitting.

FIG. 6 is a side view of an example of a pipe fitting.

FIG. 7 is a cross-section view of an example of a pipe fitting.

FIG. 8 is a cross-section view of an example of a pipe fitting.

FIG. 9 is a perspective view of an example of a pipe fitting.

FIG. 10 is a side view of an example of a pipe fitting.

FIG. 11 is a bottom view of an example of a pipe fitting.

FIG. 12 is a cross-section view of an example of a pipe fitting.

### DETAILED DESCRIPTION

Following below are more detailed descriptions of various concepts related to, and implementations of, systems, methods, and apparatuses of pipe fittings for fire protection and fire suppression systems. The various concepts introduced above and discussed in greater detail below may be implemented in any of numerous ways, including but not limited to tee, elbow, strap, and other fitting configurations.

The present disclosure generally relates to fire sprinkler systems. More particularly, the present disclosure relates to pipe fittings that can be used to connect piping to fluid distribution devices, such as sprinklers. The pipe fittings can have specific structural features to allow for improved performance, such as better flow rates at given pressures, less material usage while still achieving flow and/or strength performance targets, and various combinations thereof. The pipe fittings can be or be coupled with pipe, tee joint, elbow joint, cross joint, or pipe outlet, including threaded or grooved outlets or couplings. The pipe fittings can be used to connect various fluid distribution devices, including but not limited to sprinklers, nozzles, electronically activated sprinklers, and early suppression fast response (ESFR) sprinklers with a fluid supply.

The fitting, sprinkler, and various other components of the system can be used for storage applications, including but not limited to use for ceiling-only systems, and for ceiling heights up to and over fifty five feet. For example, the system can be used for storage commodities such as Class I, II, III or IV, Group A, Group B, or Group C plastics, elastomers, or rubber commodities, or any combination thereof. The storage commodity can be in an arrangement such as a single-row rack arrangement, a double-row rack arrangement, a multi-row rack arrangement, a palletized arrangement, a solid-piled arrangement, a bin box arrangement, a shelf arrangement, a back-to-back shelf arrangement, an on floor arrangement, and a rack without solid shelves arrangement, or any combination thereof. The system can be used in accordance with various standards, such as standards set forth by the National Fire Protection Association (NFPA) or FM Global.

For example, the fitting can include a body, a first connector on a first side of the body, and a second connector on a second side of the body. The first connector, the body, and the second connector form an internal passageway along an axis between a first port of the pipe connector and a second port of the sprinkler connector. The first port is shaped to have a concave curvature relative to a (first) plane perpendicular to the axis and extending through the internal passageway. The concave curvature can facilitate improved flow through the fitting and/or reduced material usage to form the fitting. For example, a wall of the first port and/or the first connector that forms a collar or spike to engage a remote component, such as a pipe received by the first port, can extend less into a waterway through the remote component along a portion of the wall facing or closer to a center of the waterway than a portion of the wall closer to walls (e.g., pipe walls) of the remote component. For example, one or more first points of the wall that lie in a second plane that is perpendicular to the first plane and in which the axis lies can extend further from the first plane than one or more second points outward from the one or more first points. Various structural features of the fitting, such as a radius and heights of a gasket receiver formed by the inlet, can have specific sizings to enable improved fluid flow with secure sealing of the fitting with a pipe. The fitting can be used to connect pipes with one another (e.g., threaded pipe ends with one another), as well as to connect pipes with sprinklers; for example, the first port of the first connector can be or include an inlet to connect with a pipe or pipe end, and the second port of the second connector can be or include an outlet to connect with a sprinkler (or a pipe or pipe end). For example and without limitation, the fitting can be structured to be threaded, grooved, flanged, or welded and/or used to connect pipes or other fluid flow components that are threaded, grooved, flanged, or welded.

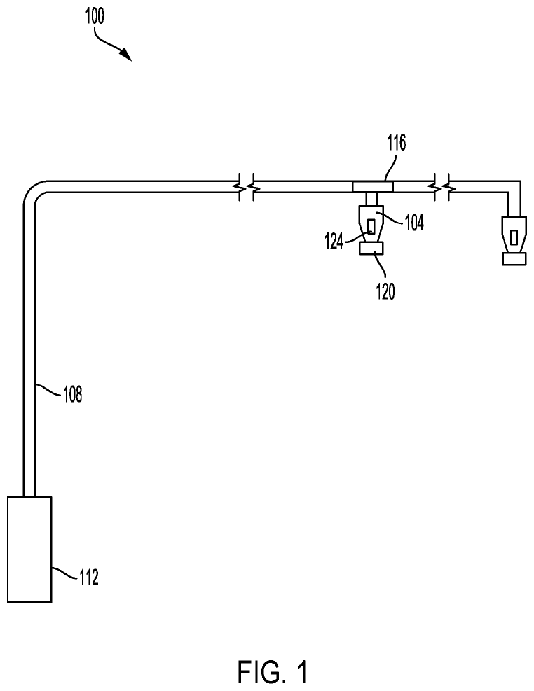

FIG. 1 depicts an example of a fire suppression system 100 (e.g., fire protection system, sprinkler system). The fire suppression system 100 can be a chemical fire suppression system. The fire suppression system 100 can distribute a fire suppressant agent onto or nearby a fire, extinguishing the fire and preventing the fire from spreading. The fire suppression system 100 can be used alone or in combination with other types of fire suppression systems (e.g., a building sprinkler system, a handheld fire extinguisher). Multiple fire suppression systems 100 can be used in combination with one another to cover a larger area (e.g., each in different rooms of a building).

The fire suppression system 100 can be used in a variety of applications. The fire suppression system 100 can be used with a variety of fire suppressant agents, including but not limited to water (e.g., may use powders, liquids, foams, or other fluid or flowable materials). The fire suppression system 100 can be used for storage applications, including ceiling-only, in-rack, or a combination of ceiling and rack sprinklers, such as to be installed for storage commodities such as Class I, IL, III or IV, Group A, Group B, or Group C plastics, elastomers, or rubber commodities, or any combination thereof. The storage commodity can be in an arrangement such as a single-row rack arrangement, a double-row rack arrangement, a multi-row rack arrangement, a palletized arrangement, a solid-piled arrangement, a bin box arrangement, a shelf arrangement, a back-to-back shelf arrangement, an on floor arrangement, and a rack without solid shelves arrangement, or any combination thereof.

The fire suppression system 100 can include or be coupled with a fluid supply 112. The fluid supply 112 can define an internal volume filled (e.g., partially filled, completely filled) with fire suppressant agent. The fluid supply 112 can provide fluid from a remote or local location to a building in which the fire suppression system 100 is located. The fluid supply may include, for example, a municipal water supply, pump, piping system, tank, cylinder, or any other source of water or fire suppression agent.

Pipe(s) 108 (e.g., one or more pipes, tubes, conduits) can be fluidly coupled with one or more sprinklers 104 by respective fittings 116. The sprinklers 104 can receive water or other fire suppressant agent from the fluid supply 112 via the pipe(s) 108 and the fittings 116. The fitting 116 can be any of a variety of fittings or couplings described herein, such as tee joint, elbow joint, cross joint, or pipe outlet, including threaded or grooved outlets or couplings.

The sprinklers 104 can each define one or more outlets, through which the fire suppressant agent exits and contacts a deflector 120, such as to form a spray of water or other fire suppressant agent that covers a desired area. The sprays from the sprinklers 104 then suppress or extinguish fire within that area. The deflectors 120 of the sprinklers 104 can be shaped to control the spray pattern of the fire suppressant agent leaving the sprinklers 104. The sprinklers 104 can be used as concealed sprinklers, pendent sprinklers, upright sprinklers, water mist nozzles, or any other device for spraying fire suppression agent.

The sprinklers 104 can include an activation element (e.g., thermal element) 124. The activation element 124 can change from a first state that prevents fluid flow out of the sprinkler 104 to a second state that permits fluid flow of the sprinkler 104 responsive to a fire condition. For example, the activation element 124 can include a glass bulb including a fluid that expands responsive to an increase in temperature (e.g., responsive to heat provided to the fluid from a fire), such as to cause the glass bulb to break responsive to the temperature meeting or exceeding a threshold temperature; the activation element 124 can include a fusible link that includes two or more pieces coupled using a solder than can melt responsive to the temperature meeting or exceeding a threshold temperature; the activation element 124 can include an electric actuator (e.g., an electrically triggered pyrotechnic actuator or electrically actuated bulb or link). The activation element 124 can have a response time index (RTI) less than or equal to 80 (m/s)^{1/2}, or less than or equal to 50 (m/s)^{1/2}.

The sprinklers 104 can be early suppression, fast response (ESFR) sprinklers, or other sprinklers and fluid distribution devices including but not limited to non-ESFR sprinklers. The sprinklers 104 can have K-factors greater than or equal to 1 GPM/(PSI)^{1/2} and less than or equal to 40 GPM/(PSI)^{1/2}. The sprinklers 104 can have K-factors greater than or equal to 14.0 GPM/(PSI)^{1/2} and less than or equal to 36.0 GPM/(PSI)^{1/2}. The sprinklers 104 can have K-factors less than 14.0 (e.g., less than 1.0) or greater than 36.0. The sprinklers 104 can be arranged (e.g., in a grid or tree arrangement over a storage commodity) to have sprinkler to sprinkler spacings greater than or equal to eight feet by eight feet and less than or equal to twelve feet by twelve feet.

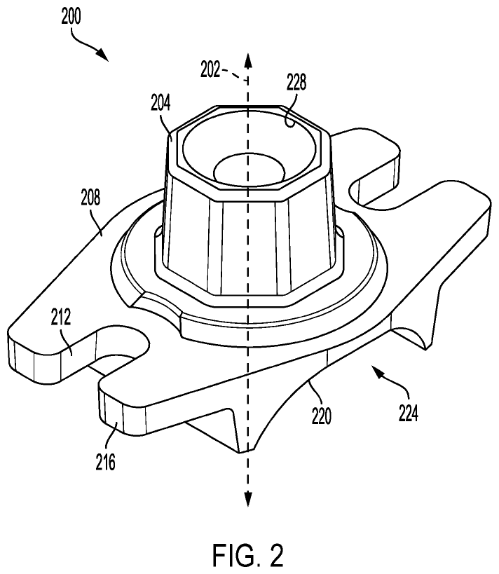

FIGS. 2-5 depict an example of a fitting 200. The fitting 200 can be used as the fitting 116 described with respect to FIG. 1. The fitting 200 can be a pipe strap. For example, the fitting 200 can be used to receive a pipe of the pipe(s) 108, such as a cut hole pipe, and connect the pipe with a remote component, such as another pipe 108 or the sprinkler 104 to allow fluid flow from the pipe(s) 108 into the remote component.

The fitting 200 includes a sprinkler connector 204 on an outlet side of the fitting 200. The sprinkler connector 204 can engage an inlet end of the sprinkler 104 to allow for fluid flow from the pipe(s) 108 through the fitting 200 into the sprinkler 104. The sprinkler connector 204 can define an axis 202.

The sprinkler connector 204 can extend from a body 208 of the fitting 200. The body 208 can extend along a plane 304 perpendicular to the axis 202. The body 208 can extend laterally outward of the sprinkler connector 204, and include at least one strap receiver 212.

The strap receiver 212 is shaped to receive a pipe strap (not shown), such as a metal strap, which extends around the pipe 108 to fasten the pipe 108 against the fitting 200. For example, the strap receiver 212 can extend inward from an outer edge 216 of the body 208 to provide an opening for the pipe strap. The strap receiver 212 can be centered about a longitudinal axis 214 of the body 208 that extends in the plane 206 perpendicular to the axis 202.

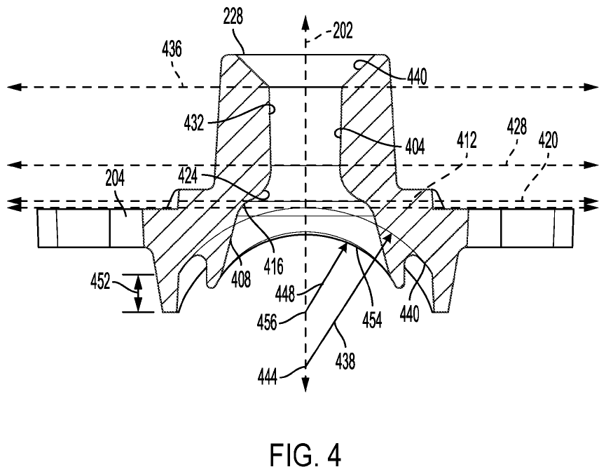

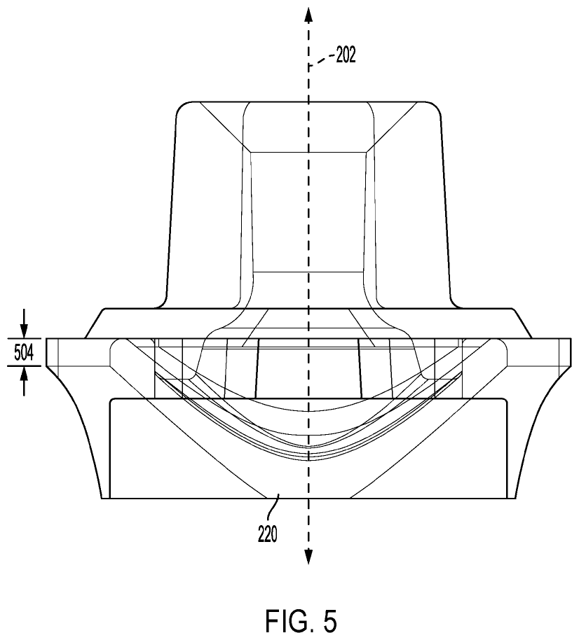

The fitting 200 includes a pipe connector 220 (e.g., locating collar, outlet spike, housing spike) on an inlet side of the fitting 200. The pipe connector 220, body 208, and sprinkler connector 204 or various combinations thereof can be integrally formed. As depicted in FIGS. 4 and 5, the sprinkler connector 204, body 208, and pipe connector 220 form an internal passageway 404 along the axis 202 from an inlet 224 (e.g., first port formed by the pipe connector 220) to an outlet 228 (e.g., second port formed by the sprinkler connector 204).

The internal passageway 404 can have a plurality of portions of various diameters to flow fluid from the pipe 108 to the sprinkler 104. For example, the internal passageway 404 can include a first portion 408 from the inlet 224 to a plane 412, a second portion 416 between the plane 412 and a plane 420, a third portion 424 between the plane 420 and a plane 428, a fourth portion 432 between the plane 428 and a plane 436, and a fifth portion 440 between the plane 436 and the outlet 228. The portions 408, 416, 424 can decrease in diameter from the inlet 224 to the plane 428, and the portions 432, 440 can increase in diameter from the plane 428 to the outlet 228. As depicted in FIGS. 4 and 5, the second portion 416 can form a concave shoulder from the first portion 408 to the third portion 424, and the third portion 424 can form a convex shoulder from the second portion 416 to the fourth portion 432. For example, the plane 412 (and thus a first end of the second portion 416) can be defined where a curvature of the internal passageway 404 changes (e.g., from convex to concave, flat to concave, or convex to flat). The internal passageway 404 can include at least some threading to connect with one or more remote components.

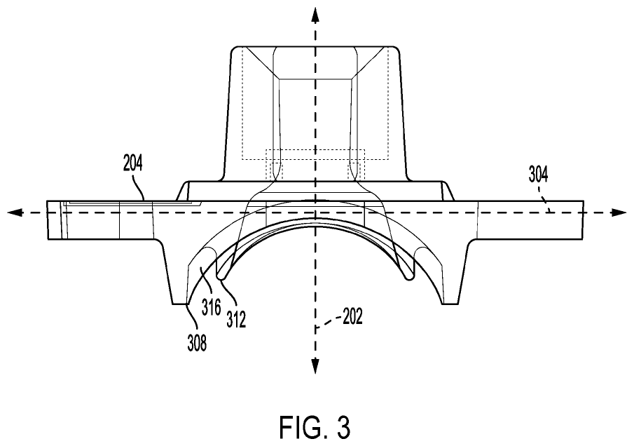

Referring further to FIGS. 2-5, the pipe connector 220 includes a plurality of walls having specific curvatures to facilitate more effective fluid flow and to receive a gasket (not shown) to form a seal between the pipe connector 220 and pipe 108. For example, the pipe connector 220 can include an outer wall 308 and an inner wall 312 inward from the outer wall 308 relative to the axis 202. The walls 308, 312 can have various shapes and/or curvatures to facilitate receiving the pipe(s) 108, such as to form flush contact or engagement with the pipe(s) 108. For example, one or both of the walls 308, 312 can be flat (e.g., as depicted in FIG. 3 for the outer wall 308) or have at least some curvature, such as convex curvature (e.g., as depicted in FIG. 3 for the inner wall 312). The outer wall 308 and/or the inner wall 312 can have a curvature to match that of the pipe 108 (e.g., to allow for smooth flow between and/or sealing between the pipe connector 220 and the pipe 108), or to extend further into or out of the pipe 108 or a flow path through the pipe 108 while still facilitating connection with or sealing of the pipes 108.

The walls 308, 312 can define a gasket receiver 316 (e.g., gasket chamber) between the outer wall 308 and inner wall 312 to receive the gasket. The outer wall 308 can extend further from the plane 304 than the inner wall 312 (e.g., in a direction parallel with the axis 202). As described further below with reference to Table 1, the gasket receiver 316 can vary in depth or height.

The outer wall 308 can define a radius 438 (e.g., radius of curvature) along a curve 440 of the outer wall 308 relative to a center of curvature 444. For example, the outer wall 308 can be shaped to have a constant radius 438.

The inner wall 308 can define a radius of curvature 448 along a curve 454 of the inner wall 312 relative to a center of curvature 456. The inner wall 308 can extend further outward from the axis 202 at points in a plane extending through the strap receivers 212 and the axis 202; for example, a projection of the inner wall 308 onto the plane 304 can be elliptical, with the major axis of the ellipse extending through the strap receivers 212.

Referring further to FIGS. 3 and 4, the walls 308, 312 can have respective lengths such that the outer wall 308 extends to an edge further from the plane 304 than the inner wall 312. In addition, as depicted in FIG. 4 and in FIG. 5, the gasket receiver 316 can vary in shape around the axis 202. For example, the gasket receiver 316 can have a height 452 in the plane depicted in FIG. 4, and a height 504 in the plane depicted in FIG. 5. The height 452 can be greater than the height 504. For example, the gasket receiver 316 can have a greater height at portions of the outer wall 308 proximate the strap receivers 212 than in between the strap receivers 212. The gasket receiver 316 can be at various distances from the internal passageway 404 (e.g., one or more walls forming the gasket receiver 316 can be closer to or further from the strap receivers 212).

Table 1 below provides example dimensions for various fittings described herein and in accordance with various fitting form factors, such as for examples of the fitting 200 (e.g., including height 452 depicted in FIG. 4's frame of reference bisecting the strap receivers 212; height 504 depicted in FIG. 5's frame of reference perpendicular to that of FIG. 4; and radius 438):

TABLE 1

| Nominal | Outlet | Gasket Depth | Gasket Depth | Gasket Edge |
|---|---|---|---|---|
| Size | Size | Height 452 | Height 504 | Radius 438 |
| [inches] | [inches] | [inches] | [inches] | [inches] |
| 1¼″ | ½″ | .211 | .176 | 1.008 |
| 1½″ | ½″ | .371 | .284 | 1.128 |
| 2″ | ½″ | .349 | .285 | 1.368 |
| 2½″ and | ½″ | .342 | .285 | 1.618 |
| 76.1 mm | | | | |
| 1¼″ | ¾″ | .200 | .158 | 1.008 |
| 1½″ | ¾″ | .362 | .268 | 1.128 |
| 2″ | ¾″ | .344 | .268 | 1.368 |
| 2½″ and | ¾″ | .339 | .268 | 1.618 |
| 76.1 mm | | | | |
| 1¼″ | 1″ | .234 | .132 | 1.008 |
| 2″ | 1″ | .336 | .243 | 1.368 |
| 1½″ | 1″ | .347 | .243 | 1.128 |
| 2½″ | 1″ | .333 | .243 | 1.618 |

The inner wall 312 can be shaped to provide for more effective flow into the first port 224, such as to reduce an amount by which the inner wall 312 (e.g., locating collar/pipe connector 220 and/or structures thereof formed by inner wall 312) extends into a waterway of a remote component to be connected to the inlet 224, which can mitigate or reduce interference by the inner wall 312 on the fluid flow (e.g., allow greater flow past the inner wall 312 and/or reduce a deleterious effect on K-factor by such interference). For example, because the inner wall 312 is structured relative to the outer wall 308 such that the center of curvature 444 corresponding to the radius of curvature 438 and curve 440 is different from the center of curvature 456 corresponding to the radius of curvature 448 and curve 454 (e.g., center of curvature 456 is further from plane 412 than center of curvature 444), the inner wall 312 can extend less into the waterway in an area along the axis 202 relative to an area outward from the axis 202 in the plane of FIG. 4 (e.g., towards the strap receivers 212). For example, a portion of the inner wall 312 projected onto the axis 202 as depicted in FIG. 4 can have a lesser height (e.g., distance from curve 444) than a portion of the inner wall 312 outward from the axis 202, such that less of the inner wall 312 (e.g., the collar/spike formed by the inner wall 312) extends into the waterway. For example, the inner wall 312 can define an axial plane in which the axis 202 lies that is perpendicular to the plane 412 (as well as the planes 420, 428, etc.), such as the plane of FIG. 5 (e.g., a plane extending out of the page of FIG. 4 and in which the axis 202 lies). A distance from the plane 412 to the curve 454 (e.g., the edge of inner wall 312) can be less in the axial plane than in one or more planes parallel with the axial plane and outward from the axis 202.

The radius 438 can be greater than the height 452 (and the height 504). For example, a ratio of the radius 438 to the height 452 can be greater than or equal to 2 and less than or equal to 10. The ratio can be greater than or equal to 3 and less than or equal to 6. The ratio can be greater than 4 and less than or equal to 5. The ratio can facilitate improved flow into the inlet 224. The radius 438 can increase with the nominal size of the fitting 200, while being less than the value of the nominal size of the fitting 200.

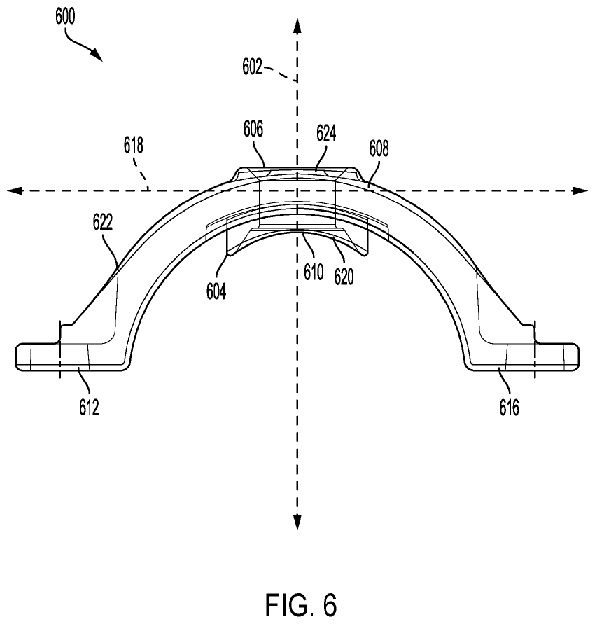

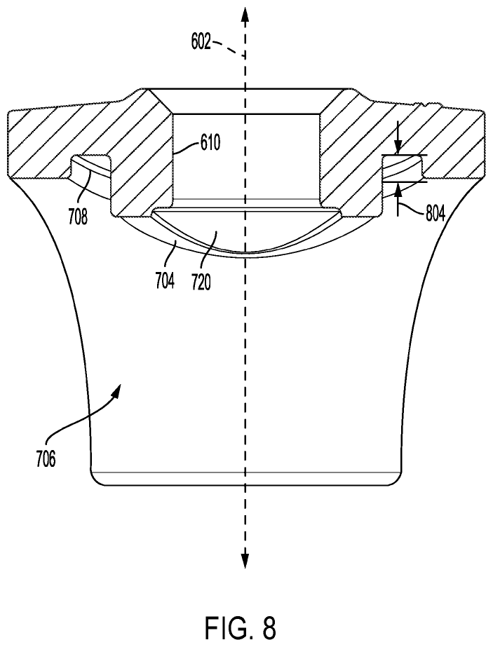

FIGS. 6-8 depict an example of a fitting 600. The fitting 600 can be a tee fitting, such as a branch outlet tee fitting. The fitting 600 can be coupled with a second fitting member (not depicted) using fasteners coupled with receivers 612, 616 to secure a pipe 108 against the fitting 600, allowing for fluid flow through the pipe 108 and through the fitting 600. As described further herein, the fitting 600 can include a first connector 604 (e.g., pipe connector; locating collar; spike) structured to more effectively flow fluid through the fitting 600 into a remote component that is coupled with the fitting 600. The fitting 600 can incorporate features of the fitting 200.

The fitting 600 includes a body 608. The body 608 can be semi-circular (e.g., have a semi-circular surface 706) to provide a shape to receive a portion of the pipe 108, such as about half of the pipe 108. The body 608 can include the first connector 604 and a second connector 606, which can form an internal passageway 610 extending along the axis 602 between an inlet 620 (e.g., first port) formed by the first connector 604 and an outlet 624 (e.g., second port) formed by the second connector 606.

The body 608 can extend in a curved manner on either side of an axis 602 to a first fastener receiver 612 and a second fastener receiver 616. For example, the body 608 can include arms 622 (e.g., a pair of arms) on either side of the axis 602 extending from a portion of the body 608 forming the first connector 604 and the second connector 606 to the fastener receivers 612, 616. The arms 622 can extend further from a plane 618 that extends through the body 608 and the internal passageway 610 than the first connector 604 to provide space to receive the pipe 108 between the arms 622 and the first connector 604.

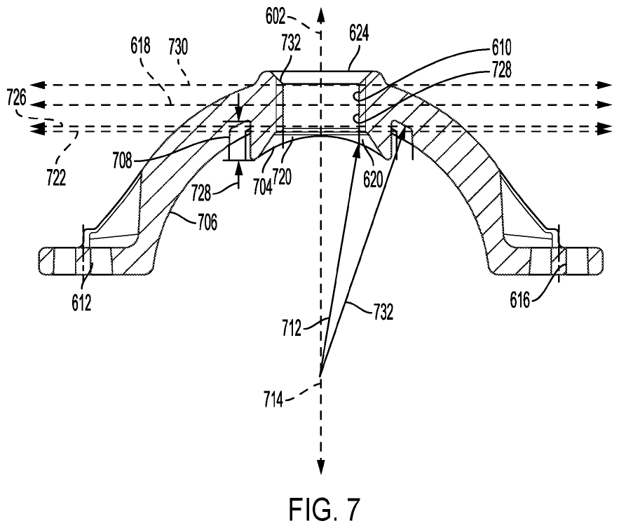

As depicted in FIG. 7, the inlet 620 can be formed by a wall 704. The wall 704 can have a concave curvature, such that points on the wall 704 closer to the axis 602 can be closer to the plane 618 than points on the wall 704 radially outward from the axis 602. A projection of the wall 704 onto the plane 618 can be elliptical (e.g., the ellipse defined by the projection can have a major axis extending through towards the fastener receivers 612, 616). The wall 704 can define a radius 712 from a center 714.

Referring further to FIG. 7, the body 608 and the wall 704 can form a gasket receiver 708. The gasket receiver 708 can extend into the body 608 towards the plane 618 relative to inner surface 706 to receive a gasket (not shown) between the body 608 and the pipe 108. The gasket receiver 708 can be adjacent to and outward from the wall 704. The gasket receiver 708 can be at various positions relative to the internal passageway 610 (e.g., one or more walls forming the gasket receiver 708 can be closer to or further from the axis 602).

As depicted in FIG. 7, the internal passageway 610 can have a plurality of portions of varying diameters to facilitate more effective fluid flow through the internal passageway 610. For example, the internal passageway 610 can have a first portion 720 decreasing in diameter from the inlet 620 to a plane 722; a second, shoulder portion 724 having a concave curvature extending from the plane 722 to a plane 726; a third portion 728, which can have a constant diameter, extending from the plane 726 to a plane 730; and a fourth portion 732 increasing in diameter from the plane 730 to the outlet 624.

Table 2 below provides example dimensions for various fittings described herein and in accordance with various fitting form factors, such as for examples of the fitting 600 (e.g., including height 728 depicted in FIG. 7's frame of reference bisecting the fastener receivers 612, 616; height 804 depicted in FIG. 5's frame of reference perpendicular to that of FIG. 4; and radius 732):

TABLE 2

| Nominal | Outlet | Gasket Depth | Gasket Depth | Gasket Edge |
|---|---|---|---|---|
| Size | Size | Height 728 | Height 804 | Radius 732 |
| [inches] | [inches] | [inches] | [inches] | [inches] |
| 1¼″ | ½″ | .193 | .187 | .958 |
| 1½″ | ½″ | .296 | .254 | 1.098 |
| 2″ | ½″ | .321 | .240 | 1.313 |
| 2½″ | ½″ | .377 | .311 | 1.575 |
| 76.1 mm | ½″ | .349 | .286 | 1.646 |
| 1¼″ | ¾″ | .285 | .191 | .958 |
| 1½″ | ¾″ | .351 | .236 | 1.078 |
| 2″ | ¾″ | .337 | .243 | 1.313 |
| 2½″ | ¾″ | .373 | .294 | 1.575 |
| 76.1 mm | ¾″ | .346 | .269 | 1.646 |
| 2″ | 1″ | .329 | .218 | 1.313 |
| 2½″ | 1″ | .367 | .267 | 1.575 |
| 1½″ | 1″ | .260 | .212 | 1.078 |
| 1¼″ | 1″ | .228 | .163 | .958 |
| 76.1 mm | 1″ | .340 | .244 | 1.646 |

In a similar manner as described with respect to the inner wall 316 of the fitting 200, the wall 704 can be shaped to provide for more effective flow into the inlet 624. For example.

The radius 732 can be greater than the height 728 (and the height 804). For example, a ratio of the radius 732 to the height 728 can be greater than or equal to 2 and less than or equal to 10. The ratio can be greater than or equal to 3 and less than or equal to 8. The ratio can be greater than or equal to 4 and less than or equal to 6. The radius 732 can increase with the outlet size of the fitting 600 and be greater than 0.5 times the nominal size of the fitting 600 (and less than the nominal size of the fitting 600).

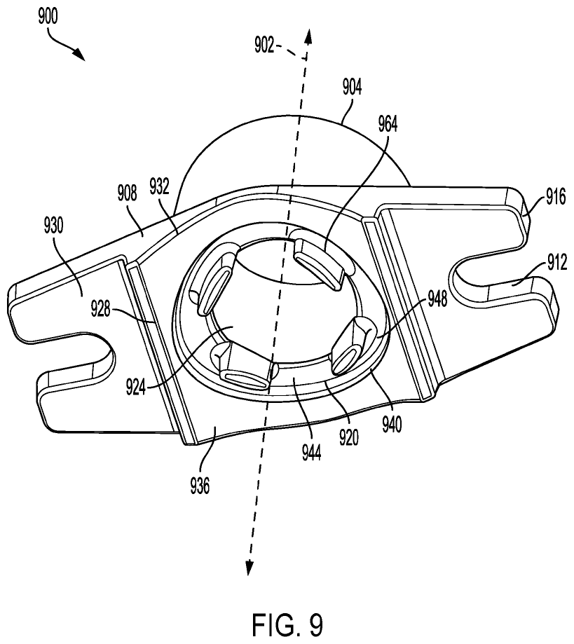

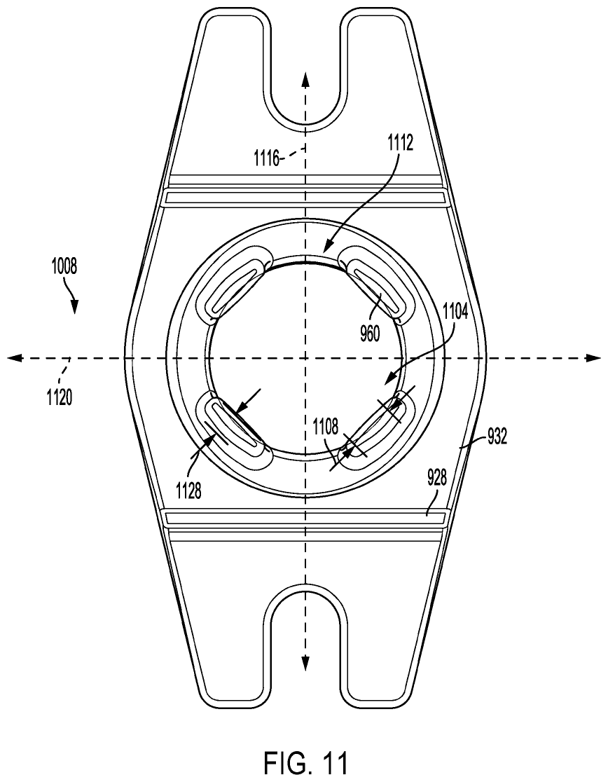

FIGS. 9-11 depict an example of a fitting 900. The fitting 900 can incorporate features of various fittings described herein, including but not limited to the fitting 200. For example, the fitting 900 can be a pipe strap to receive a pipe of the pipe(s) 108, such as a cut hole pipe, and connect the pipe with the sprinkler 108 to allow fluid flow from the pipe(s) 108 into the sprinkler. As depicted in FIGS. 9-11, the fitting 900 can include a sprinkler connector 904 to engage an inlet end of the sprinkler 104, a body 908 from which the sprinkler connector 904 extends, and a pipe connector 920. The body 908 can include at least one strap receiver 912 that extends inward from an outer edge 916 of the body 908 to provide an opening to receive a pipe strap.

The fitting 900 (e.g., the sprinkler connector 904, body 908, and pipe connector 920) can form an internal passageway 924 through the fitting 900. The internal passageway 924 can extend around an axis 902. The internal passageway 924 can have various portions having various diameters and/or curvatures.

As depicted in FIGS. 9-11, the pipe connector 920 can include a plurality of walls and/or wall portions having specific structures and/or curvatures to facilitate more effective fluid flow and to receive a gasket (not shown) to form a seal between the pipe connector 920 and pipe 108. For example, the pipe connector 920 can include at least one first wall 928 spaced from a surface 930 of the body 908 in which the strap receiver 912 is formed (e.g., the surface 930 extending out to the outer edge 916). The first walls 928 can extend further from a plane 1004 along a surface 1008 from which the sprinkler connector 904 extends than the surface 930.

The pipe connector 920 can include at least one second wall 932 extending across the axis 902, such as to connect the first walls 928, such as to form a pipe receiver 936. For example, the second walls 932 can have concave curvatures to conform to an outer surface of the pipe(s) 108.

The pipe connector 920 can include at least one third wall 940 inward from the second wall 932 and outward from the internal passageway 924. The third wall 940 can form a shoulder to a surface 944, such as to receive a gasket between the surface 944 and third wall 940.

As depicted in FIGS. 9-11, the fitting 900 can include a plurality of members 960 (e.g., tabs, extensions, wall portions). The members 960 can be used to engage the pipes 108 received by the fitting 900 (e.g., in a similar manner as the inner wall 312 described with reference to FIGS. 3-5). For example, the members 960 can collectively form a collar to couple with and/or be at least partially received by the pipes 108 in a similar manner as the inner wall 312.

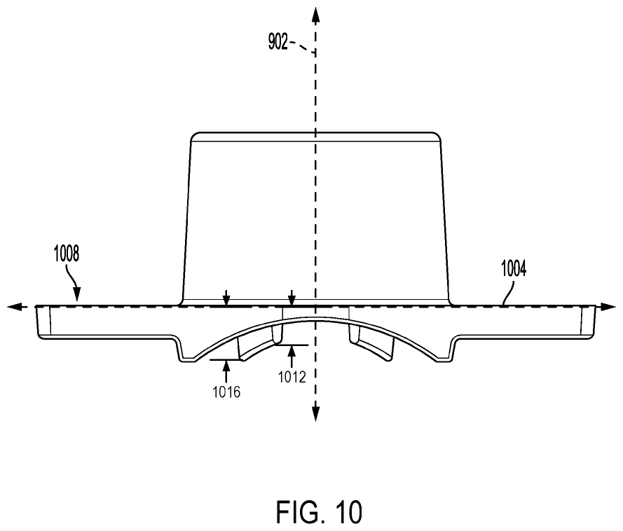

The members 960 can extend out of at least one of the surface 944 and the internal passageway 924. The members 960 can extend in a direction parallel with the axis 902. The members 960 can extend about a same distance (e.g., within twenty percent of; within ten percent of; within one percent of) from the plane 1004 and/or the surface 1008 as the first walls 928, such as to allow for uniform engagement with the pipes 108. As depicted in FIG. 10, a distance 1012 by which a side of the members 960 proximate to the axis 902 extend from the plane 1004 can be less than a distance 1016 by which an opposite side of the members 960 extend, such that proximate side of the members 960 extend less into the waterway to reduce or mitigate effects on the fluid flow, while the opposite distal side can extend further along the pipe wall to engage the received pipes 108.

As depicted in FIGS. 9-11, the members 960 can include multiple members, such as at least two members 960, such as less than eight members 960. For example, the members 960 can include four members 960 (or various other numbers of members 960).

The members 960 can be arranged around a portion of a perimeter of the internal passageway 924 to allow for effective engagement with the pipe 108, while reducing the amount of material of the fitting 900. For example, the members 960 can be formed around between thirty percent and seventy percent of a perimeter 1104 of the internal passageway 924. Each member 960 can have an extent 1108 between six percent and twenty percent of the perimeter 1104. The members 960 can be arranged to form gaps 1112 between the members 960. For example, the members 960 can be arranged so that the gaps 1112 are formed along axes 1116, 1120, where the axis 1116 is perpendicular to the axis 902 and extends in a plane through the strap receivers 912, and the axis 1120 is perpendicular to the axis 902 and to the axis 1116. The arrangements of the members 960 around the perimeter 1104 can be made to allow for the members 960 to engage the pipes 108 while being out of a flow path through the pipes 108. The members 960 can be spaced from the third wall 940 (e.g., to form gaps 948 between the members 960 and the third wall 940.

The members 960 can be shaped to receive a gasket (e.g., together with the surface 944 and second wall 940). For example, the members 960 can include respective outer surfaces 964 that are shaped to receive the gasket, such as to have concave curvatures (e.g., extend inward towards the axis 902 in a direction away from the plane 1008).

The members 960 can have an oblong shape, such as a cylindrical or oval shape. For example, a perimeter of the members 960 in a plane perpendicular to the axis 902 can be oblong. The extent 1108 can be a first dimension of the members 960 that is greater than or equal to 0.1 inches and less than or equal to 1 inch (e.g., greater than or equal to 0.2 inches and less than or equal to 0.7 inches; greater than or equal to 0.3 inches and less than or equal to 0.5 inches; 0.375 inches). A second dimension 1128 of the members 960 can be greater than or equal to 0.05 inches and less than or equal to 0.5 inches (e.g., greater than or equal to 0.1 inches and less than or equal to 0.2 inches; 0.156 inches).

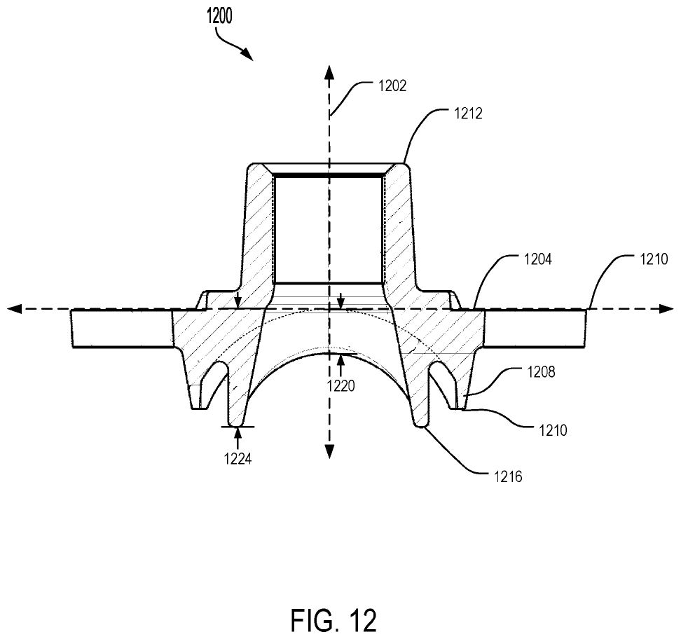

FIG. 12 depicts an example of a fitting 1200. The fitting 1200 can incorporate features of various fittings described herein (and/or features of the fitting 1200 can be incorporated in various fittings described herein), including but not limited to the fitting 200.

The fitting 1200 can include a body 1204 having a first connector 1208 and a second connector 1212 to forming a passageway for fluid flow through the connectors 1208, 1212 along an axis 1202. The fitting 1200 can define a plane 1210 perpendicular to the axis 1202 along a surface from which the second connector 1210 extends (e.g., opposite the first connector 1208).

As depicted in FIG. 12, the first connector 1208 can have an inner wall 1216 having distance 1220 from the plane 1210 in an axial plane (e.g., extending out of the plane of FIG. 12) in which the axis 1202 lies and that is perpendicular to the plane 1210, and can have a distance 1224 in one or more planes outward from the axial plane and parallel with the axial plane. As such, the portion(s) of the inner wall 1216 along the axial plane can have reduced or minimal interference with fluid flow into the fitting 1200, while the portion(s) outward from the axial plane can effective couple with the received pipe 108. As depicted in FIG. 12, outward portions of the inner wall 1216 can extend further from the plane 1210 than respective portions of outer wall 1210.

As utilized herein, the terms “approximately,” “about,” “substantially”, and similar terms are intended to include any given ranges or numbers+/−10%. These terms include insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The construction and arrangement of the fitting assembly as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A pipe fitting, comprising:
a body;
a first connector on a first side of the body; and
a second connector on a second side of the body, the first connector, the body, and the second connector forming an internal passageway along an axis from a first port of the first connector to a second port of the second connector,
the first port shaped to have a concave curvature relative to a plane perpendicular to the axis and extending through the internal passageway.

2. The pipe fitting of claim 1, comprising:
the first port has a first point on the axis and a second point radially outward from the axis, the second point further from the plane than the first point such that the first port has reduced interference with fluid flow from a component coupled with the first connector relative to the second point.

3. The pipe fitting of claim 1, comprising:
the body extends outward from the axis to a first strap receiver on a first side of the internal passageway and a second strap receiver on a second side of the internal passageway, the first strap receiver and the second strap receiver extend through the plane.

4. The pipe fitting of claim 1, comprising:
the body comprises a pair of arms curving outward from the axis to a first fastener receiver on a first side of the axis and a second fastener receiver on a second side of the axis, the internal passageway between the second connector and the fastener receivers relative to a plane perpendicular to the axis.

5. The pipe fitting of claim 1, comprising:
the pipe fitting is a strap fitting or a tee fitting.

6. The pipe fitting of claim 1, comprising:
a projection of the first port onto the plane is elliptical.

7. The pipe fitting of claim 1, comprising:
a portion of the internal passageway between the first port and the second port has a lesser diameter than each of the first port and the second port.

8. The pipe fitting of claim 1, comprising:
a gasket receiver formed by the first connector and the body outward from the first port.

9. The pipe fitting of claim 1, comprising:
a gasket receiver formed by the pipe connector and the body outward from the inlet, the gasket receiver having an outer wall varying in height about a radial path around the axis.

10. The pipe fitting of claim 1, comprising:
a gasket receiver formed by the pipe connector and the body outward from the inlet, the gasket receiver having an outer wall varying in height about a radial path around the axis, a ratio of a first value of the height to a second value of the height is greater than or equal to 1.05 and less than or equal to 1.5.

11. The pipe fitting of claim 1, comprising:
a gasket receiver formed by the pipe connector and the body outward from the inlet, the gasket receiver having a radius greater than a height of the gasket receiver.

12. The pipe fitting of claim 1, comprising:
a gasket receiver formed by the pipe connector, the gasket receiver having an outer wall and a plurality of tabs inward from the outer wall.

13. A pipe strap fitting, comprising:
a body;
a sprinkler connector extending from the body along an axis to an outlet, the body defining a plane perpendicular to the axis, the body having at least one strap receiver formed along the plane outward from the axis; and
a pipe connector extending on an opposite side of the body from the sprinkler connector along the axis to an inlet, the sprinkler connector, the pipe connector, and the body forming an internal passageway along the axis between the inlet and the outlet,
the pipe connector comprising an inner wall forming the inlet and an outer wall, the inner wall and the outer wall forming a gasket receiver between the inner wall and the outer wall, an edge of the outer wall further from the plane than an edge of the inner wall, the inner wall and the outer wall having concave curvatures relative to the plane.

14. The pipe strap fitting of claim 13, comprising:
the inlet has a first point on the axis and a second point radially outward from the axis, the second point further from the plane than the first point.

15. The pipe strap fitting of claim 13, comprising:
the body extends outward from the axis to a first strap receiver on a first side of the internal passageway and a second strap receiver on a second side of the internal passageway, the first strap receiver and the second strap receiver extend through the plane.

16. The pipe strap fitting of claim 13, comprising:
a projection of the inlet onto the plane is elliptical.

17. The pipe strap fitting of claim 13, comprising:
a gasket receiver formed by the pipe connector and the body outward from the inlet, the gasket receiver having an outer wall varying in height about a radial path around the axis, the gasket receiver having a radius greater than a height of the gasket receiver.

18. The pipe strap fitting of claim 13, comprising:
the inner wall comprises a plurality of tabs.

19. A tee outlet fitting, comprising:
a body;
a sprinkler connector extending from the body along an axis to an outlet, the body defining a plane perpendicular to the axis, the body having at least one strap receiver formed along the plane outward from the axis; and
a pipe connector extending on an opposite side of the body from the sprinkler connector along the axis to an inlet, the sprinkler connector, the pipe connector, and the body forming an internal passageway along the axis between the inlet and the outlet,
the pipe connector comprising a wall forming the inlet on an inner side of the wall and a gasket receiver on an outer side of the wall, the wall extending further from the plane at one or more outer points outward from the axis than one or more inner points aligned with the axis.

20. The tee outlet fitting of claim 19, comprising:
the body comprises a pair of arms curving outward from the axis to a first fastener receiver on a first side of the axis and a second fastener receiver on a second side of the axis, the internal passageway between the sprinkler connector and the fastener receivers relative to a plane perpendicular to the axis;
a portion of the internal passageway between the inlet and the outlet has a lesser diameter than each of the inlet and the outlet;
a height of the gasket receiver varies about a radial path around the axis; and
the gasket receiver has a radius greater than a height of the gasket receiver.
